(19) United States
(12) Patent Application Publication
(10) Pub. No.: US 2008/0155224 A1
(43) Pub. Date: Jun. 26, 2008

(54) System and method for performing input/output operations on a data processing platform that supports multiple memory page sizes

(75) Inventors: Carl R. Crandall, Hugo, MN (US); Michael J. Heideman, North Oaks, MN (US); Michael C. Otto, Stillwater, MN (US); John T. Rusterholz, Roseville, MN (US)

Correspondence Address: UNISYS CORPORATION;MS 4773, PO BOX 64942, ST. PAUL, MN, 55164-0942, US

(73) Assignee: Unisys Corporation

(21) Appl. No.: 11/643,264

(22) Filed: Dec. 21, 2006

(51) Int. Cl. G06F 12/00

(52) U.S. Cl. 711/203; 711/E12.016

(57) ABSTRACT

A legacy operating system (OS) of a type generally associated with an enterprise-level, legacy data processing platform such as a mainframe is instead provided on a commodity data processing platform such as a personal computer. The legacy OS is adapted to communicate with legacy IOP devices of the type generally associated with the legacy platform to provide data protection mechanisms for legacy data. To initiate an I/O operation, a commodity OS executing on the commodity platform allocates a memory buffer and provides the virtual buffer address to the legacy OS. The legacy OS uses this address to construct a description of an I/O operation to be performed using the buffer. The description is then translated from one referencing a first memory page size in virtual address space into a description referencing a different page size in physical address space so that legacy IOP can complete the operation.

### RELATED APPLICATIONS

The following commonly-assigned patent applications have some subject matter in common with the current Application:

Ser. No. ______ filed on even date herewith entitled “System and Method for Providing Protected Input/Output Operations within a Data Processing Environment”, Attorney Docket Number RA-5826.

Ser. No. ______ filed on even date herewith entitled “System and Method for Synchronizing Memory Management Functions of Two Disparate Operating Systems”, Attorney Docket Number RA-5827.

### FIELD OF THE INVENTION

The current invention relates to maintaining secure and coherent data within a data processing environment; and more particularly, to an I/O system and method for providing secure I/O operations within a data processing environment that supports multiple memory page sizes.

### BACKGROUND OF THE INVENTION

In the past, software applications that require a large degree of data security and recoverability were traditionally supported by mainframe data processing systems. Such software applications may include those associated with utility, transportation, finance, government, and military installations and infrastructures. Such applications were generally supported by mainframe systems because mainframes provide a high degree of data redundancy, recoverability, and data security.

As smaller “off-the-shelf” commodity data processing systems such as personal computers (PCs) increase in processing power, there has been some movement towards using such systems to support industries that historically employed mainframes for their data processing needs. For instance, one or more personal computers may be interconnected to provide access to “legacy” data that was previously stored and maintained using a mainframe system. Going forward, the personal computers may be used to update this legacy data, which may comprise records from any of the aforementioned sensitive types of applications. This scenario presents several challenges, as follows.

First, as previously alluded to, the Operating Systems (OSes) that are generally available on commodity-type systems do not include the security and protection mechanisms needed to ensure that legacy data is adequately protected. For instance, a commodity OS such as Linux utilizes an in-memory cache to boost performance. This in-memory cache may store data that has been retrieved from a mass storage device. Based on the types of requests made by application programs to this data, some updates to this cached data may be retained within the in-memory cache and not written back to mass storage devices for some period of time. Other updates may be initiated directly to the mass storage devices. This may lead to a “data coherency” problem wherein an older update that had been retained within the in-memory cache may eventually overwrite newer data that was stored directly to the mass storage devices. A commodity OS will generally not guard against this undesired result. Instead, the application programmer must ensure that this type of operation does not occur. This becomes increasingly difficult in a multi-processing environment wherein many different applications are making I/O requests concurrently.

In addition to the foregoing limitations, commodity OSes such as UNIX and Linux allow operators a large degree of freedom and flexibility to control and manage the system. For instance, a user within an UNIX environment may enter a command from a shell prompt that could delete a large amount of data stored on mass storage devices. This may occur without the OS either intervening or providing a warning message. Such actions may be unintentionally initiated by novice users who are not familiar with the often cryptic command shell and other user interfaces associated with these commodity OSes.

Problems similar to those discussed above arise in systems that use I/O emulators to perform I/O operations. An Input/Output Processor (IOP) emulator is a software system that is loaded into main memory to emulate the functions that would be provided by corresponding IOP hardware of the type that is typically present in mainframe-type systems. An IOP emulator may be useful, for instance, when a data processing system is being made to appear as though it is coupled to a peripheral that is of a type that is generally not supported by that system.

The commodity OS performs I/O operations using the IOP emulator in conjunction with existing device drivers. This provides the commodity OS with visibility to all of the mass storage devices that are supported by the IOP emulator. This visibility allows the commodity OS to readily facilitate the updating of data to any of these mass storage devices according to user commands or requests issued from application programs with few, if any, protection mechanisms to prevent inadvertent or malicious destruction of data.

Thus, what is needed is a system and method to address at least some of the aforementioned limitations.

### SUMMARY OF THE INVENTION

According to the invention, a legacy operating system (OS) of the type that is generally associated with an enterprise-level data processing system (“legacy platform”) is provided on a commodity data processing system. The legacy OS may be the 2200 OS commercially-available from Unisys Corporation, for example. The commodity data processing system (“commodity platform”) may be a PC or workstation, for instance.

In one embodiment, a commodity OS also executes on the commodity platform along with the legacy OS. The commodity OS may be Windows™ commercially-available from Microsoft Corporation, UNIX, Linux, or some other operating system. In one embodiment, the legacy OS communicates with this commodity OS via a standard application program interface (API) of the commodity OS.

Legacy OS may be implemented using a different machine instruction set than that which is executed by the commodity platform. In this embodiment, the instruction set in which legacy OS is implemented (that is, the “legacy instruction set”) is emulated by an emulation environment provided on the commodity platform. This emulation environment may use any type of one or more emulators known in the art, such as interpreters, cross-compilers, or any other type of system for allowing a legacy instruction set to execute on a commodity platform.

The legacy OS is adapted to communicate with various legacy IOPs that interface with mass storage devices. The legacy OS and legacy IOPs provide data protection and recovery capabilities that ensure that data stored on the mass storage devices will be maintained in a coherent state. Such capabilities guard against unintentional or unauthorized data deletions or updates. The data protection aspects of the system are enhanced by the existence of the legacy IOP within the system. The legacy IOP hides the interconnected mass storage devices from view of the commodity OS. Because of this, unauthorized I/O operations may not be initiated to the mass storage devices via the commodity OS.

According to the invention, all I/O operations to mass storage devices that are interconnected to the legacy IOPs must be initiated via the legacy OS rather than the commodity OS. This occurs upon request of an application program that interfaces with the legacy OS, or upon a request initiated by the legacy OS on its own behalf.

When an I/O request is to be initiated, the legacy OS makes a request to the commodity OS for a buffer. This request may be made via a standard API of the commodity OS that is adapted for use by any software application that requires memory allocation. Upon receipt of such a request, the commodity OS obtains a buffer and returns a virtual address of the buffer within “virtual address space” to the legacy OS.

As is known in the art, “virtual address space” refers to all of the addressable storage space in the system which, through storage allocation techniques, is made to appear as though it is part of main memory. More specifically, combinations of hardware, firmware, and operating system logic cooperate to automatically swap portions of code and data between other storage devices (e.g., mass storage device and main memory so that it appears that all code and data in virtual address space resides within main memory.

When legacy OS is operating within its native legacy environment, a physical (rather than a virtual) address is returned when the legacy OS makes a request to its memory allocation utilities for memory. As is known in the art, physical addresses are addresses that are used to access existing physical memory. All of the physical addresses within the system make up the “physical address space” of that system. As may be appreciated, physical address space may be much smaller than virtual address space.

As previously mentioned, when the legacy OS is operating in a commodity environment, rather than its native legacy environment, legacy OS does not “know” that in response to a request for memory allocation a virtual, rather than a physical, address is being returned. Legacy OS views any allocated buffer space as residing within a block of contiguous physical memory. Therefore, legacy OS resides the returned virtual address as though it is a physical address. Specifically, the legacy OS builds a request packet at the virtual address that contains a description of an I/O operation that is to be initiated to fulfill the I/O request.

After creation of the request packet is complete, processing of the packet may begin. If legacy OS and legacy IOP were executing on a legacy platform, the legacy IOP would begin processing the request packet directly. However, because legacy OS is instead operating on a commodity platform, some translation of the information contained within the packet is required.

Translation of the request packet is needed for several reasons. First, legacy IOP expects the packets to contain physical, not virtual, addresses. Although legacy OS “thinks” it has created a request packet containing physical addresses, this is not really the case, as described above. Therefore, each virtual address contained in the request packet must be converted to at least one physical address that describes how the buffer in virtual address space maps to physical (“real”) memory.

In addition to the foregoing, the legacy OS and the commodity OS may not utilize the same page sizes within physical memory. For example, in one embodiment, legacy OS utilizes a maximum page size of 32K bytes, whereas commodity OS and the commodity platform enforce a maximum page size of 4K bytes. Because of this, when legacy OS requests a buffer of 32K bytes, the address it receives in virtual address space is viewed by legacy OS as a contiguous 32K block of physical memory. However, the allocated memory actually consists of multiple 4K byte pages in physical address space that are, in all likelihood, non-contiguous.

Because of the above-described discrepancies, the request packet must be translated before the legacy IOP may begin to process it. Translation of the packet is performed by interface logic, which in one embodiment is provided by an IOP driver. In one embodiment, this driver converts the packet into a translated packet stored elsewhere in memory.

During the translation process, each virtual address from the packet must be resolved into one or more physical addresses. Each physical address represents, at most, a 4K byte page of physical memory. Each such address is associated with a description of a respective I/O operation that will be performed using the associated buffer.

As may be appreciated, the original request packet created by the legacy OS contains a description of an I/O operation to/from a 32K byte buffer in virtual address space. This description must be translated into a translated request packet that contains multiple descriptions of eight or more I/O operations, each to a different buffer in physical memory that is, at most, 4K bytes in length.

After the translation process occurs, the legacy IOP may process the one or more I/O operations to physical address space that are described by the translated packet. When this processing is completed, the legacy IOP stores status to a completion queue.

The legacy OS cannot interpret the status on the completion queue directly. This is because that status may contain an address expressed in terms of physical address space. Therefore, according to the current embodiment, some status translation is required.

In one embodiment, the translation of status is supported by the following mechanism. When the IOP driver begins processing the original request packet to create the translation, the IOP driver assigns a label to the I/O operation described by the original packet. As the translation is created, this label is assigned to each of the one or more corresponding descriptions of I/O operations in physical address space that are contained within the translated request packet. Legacy IOP then executes the one or more I/O operations to physical memory and determines whether any of these operations completed in a non-standard way.

If an I/O operation completed in a non-standard way, the label assigned to that operation is used to identify the corresponding I/O operation to virtual address space that was contained in the original packet. This identification can then be used by the legacy OS to address any non-standard completion of the operation and to perform recovery as need.

In the foregoing manner, legacy OS and legacy IOP may be executed on a commodity platform without the need to change either entity. Use of legacy OS and legacy IOP ensure that data on mass storage devices is maintained in a coherent state, and that unauthorized malicious or inadvertent operations are not performed that will corrupt this data.

Although the foregoing embodiment does not require any changes to legacy OS and legacy IOP, the translation processes described above may, in some situations, slow throughput. Therefore, in an alternative embodiment of the invention, legacy OS is adapted to utilize the same page size as commodity OS. This eliminates the need to translate a single I/O operation performed to one page in virtual address space into multiple I/O operations occurring in physical address space. This further eliminates some of the translation that is needed if the I/O operation completed in a non-standard way.

Even if both the legacy OS and commodity OS are adapted to utilize the same page size in the manner discussed above, some translation is still needed. This is because the legacy OS operates in virtual address space, whereas the legacy IOP operates in physical address space. Therefore, according to this alternative embodiment, interface logic provides a corresponding physical address for each virtual address contained in a request packet. In one specific implementation, this occurs as follows.

On the commodity platform, virtual addresses are provided using a 128-bit address field. The legacy OS and the legacy IOP utilize addresses that are smaller than this 128-bit address field. In one embodiment, these legacy addresses are only 72 bits wide. Thus, unused bits are available in the address field. These unused bits are employed to store a corresponding physical address for each virtual address. That is, interface logic is used to store a corresponding physical address in the unused bits of each virtual address field. Further, the legacy IOP is adapted to extract the physical addresses from the unused bits. In this manner, the amount of translation required to process the request packet can be further minimized to increase throughput.

According to one embodiment of the invention, a computer-implemented method of performing input/output (I/O) operations is disclosed. The method includes building, by a first OS, a first description of an I/O operation that is based on a first memory page size that is different from that used by a data processing system on which the first OS is running. The method also includes creating from the first description a translation that is based on a second memory page size used by the data processing system. An I/O processor then performs one or more I/O sub-operations that are described by the translation.

Another aspect of the invention relates to a data processing system that includes an instruction processor (IP) and a first operating system (OS) being executed by the IP. The first OS creates a first description of an I/O operation that is based on a first memory page size that is different than a second memory page size utilized by the IP. A driver coupled to the first OS creates a translation of the first description based on the second memory page size. An IOP coupled to the first OS executes the I/O operation in accordance with the second description.

Yet another embodiment provides a computer readably medium having stored thereon instructions for performing a method. The method includes allocating, by an operating system (OS), a buffer based on a memory page size. This virtual address of the buffer is provided to another OS. The method further includes building, by the other OS, a description of an I/O operation to be performed using the buffer, the description being based on a memory page size that is different from that used to allocate the buffer, and creating from the description a translated description that is based on the memory page size used to allocate the buffer. An I/O processor compatible with the other OS performs the I/O operation as described by the translated description.

Other scopes and aspects of the invention will become apparent from the following description and the accompanying drawings.

### BRIEF DESCRIPTION OF THE DRAWINGS

FIG. 1 is a block diagram of an exemplary commodity-type data processing system that may be adapted for use with the current invention.

FIG. 2 is a block diagram of a data processing system according to the current invention.

FIG. 3 is a block diagram that illustrates the memory constructs used to support I/O operations according to the current invention.

FIG. 4 is a block diagram illustrating translation performed by interface logic to convert a request packet into a translated request packet.

FIG. 5 is block diagram illustrating one method of converting a buffer descriptor pointer for a translated request packet into a buffer descriptor pointer for an un-translated request packet.

FIG. 6 is a flow diagram of one method of performing I/O operations according to the polling embodiment of the invention.

FIG. 7 is a flow diagram of one method of translating a request packet according to one embodiment of the invention.

FIG. 8 is a block diagram that illustrates fast mode according to one embodiment of the invention.

FIG. 9 is a flow diagram of a fast-mode embodiment of the current invention.

FIG. 10 is a flow diagram of an alternative fast-mode embodiment of the current invention.

### DETAILED DESCRIPTION OF THE INVENTION

### I. System-Level Information

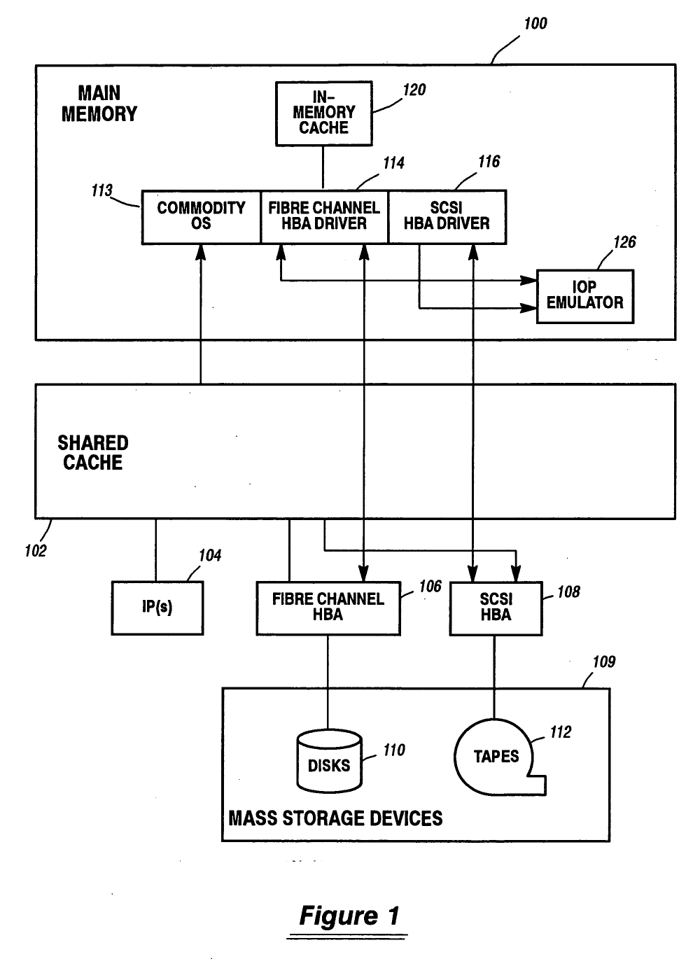

FIG. 1 is a block diagram of an exemplary commodity-type data processing system such as a personal computer, workstation, or other “off-the-shelf” hardware (hereinafter “commodity platform”) that may be adapted for use with the current invention. A main memory 100 is coupled to a shared cache 102. The shared cache is, in turn, coupled to one or more instruction processors (IPs) 104 which may be an instruction processor commercially available from Unisys Corporation, Intel Corporation, Advanced Micro Devices, Inc., or some other vendor.

The system of FIG. 1 also includes one or more Host Bus Adaptors (HBAs) such as fibre channel HBA 106 and SCSI HBA 108. These HBAs are shown coupled to the system via shared cache 102, although in another embodiment they may be coupled to main memory 100 via some type of bridge or other circuit. These adaptors provide an interface to the interconnected mass storage devices 109, including disks 110 and tapes 112, respectively.

A commodity operating system (OS) 113 such as UNIX, Linux, Windows™ that is commercially-available from Microsoft Corporation, or the like resides within main memory 100 of the illustrated system. These types of commodity OSes perform input/output operations from/to mass storage devices 109 using applicable device drivers. For instance, commodity OS 113 employs a fibre channel HBA driver 114 to perform I/O operations to the various disks 110 coupled to the fibre channel HBA 106. Likewise, the OS uses the SCSI HBA driver 116 to perform I/O operations to the tapes coupled to the SCSI HBA 108.

Mass storage devices 109 may store highly sensitive data such as banking records, data used to support transportation and utility infrastructures, government information, and so on. Because loss of such data could have catastrophic effects, it is generally advantageous to update this data using data protection and security mechanisms of the type typically found on legacy data processing systems (e.g., mainframes). In today's world, however, smaller commodity data processing systems such as PCs are increasingly being used to update this type of sensitive data. As discussed above, this presents several challenges.

First, commodity OSes generally do not include the type of security and protection mechanisms needed to ensure that legacy data is adequately protected. For instance, a commodity OS such as Linux utilizes an in-memory cache 120 to boost performance. This in-memory cache may store data that has been retrieved from mass storage devices 109. Based on the types of requests made by application programs to this data, some updates to this cached data may be retained within the in-memory cache 120 and not written back to mass storage devices 109 for some period of time. Other updates may be initiated directly to the mass storage devices 109. This may lead to a “data coherency” problem wherein an older update that had been retained within in-memory cache 120 may eventually overwrite newer data that was stored directly to cache. A commodity OS will generally not guard against this undesired result. Instead, the application programmer must ensure that this type of operation does not occur. This becomes increasingly difficult in a multi-processing environment wherein many different applications are making I/O requests concurrently.

In addition to the foregoing limitations, commodity OSes such as UNIX and Linux allow operators a large degree of freedom and flexibility to control and manage the system. For instance, a user within an UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these commodity OSes.

The above description focuses on a commodity-type OS that communicates directly with peripheral devices (e.g., the HBAs) via corresponding device drivers. Another approach for performing I/O operations within a commodity-type system is to utilize an Input/Output Processor (IOP) emulator 126 to communicate with the peripheral devices. An IOP emulator is a software system that is loaded into main memory 100 to emulate the functions that would be provided by corresponding IOP hardware of the type that is typically present in mainframe-type systems. An IOP emulator 126 may be useful, for instance, when a data processing system is being made to appear as though it is coupled to an IOP that is of a type that is generally not supported by that system.

When using an IOP emulator, the commodity OS 113 initiates I/O operations via the emulator operating in conjunction with existing device drivers, such as the fibre channel HBA driver 114 and the SCSI HBA driver 116. According to this method, the commodity OS has visibility to all of the HBAs and mass storage devices 109 that are coupled to, and supported by, the IOP emulator 126. This visibility leads to problems that are similar to those described above. That is, the commodity OS may readily facilitate the updating of data to any of the mass storage devices 109 according to user commands or requests issued from application programs. There are few, if any, protection mechanisms in place other than those implemented by the applications themselves to ensure that data coherency is maintained. Moreover, only limited safety features are provided to ensure that inadvertent updates and deletions do not occur. Finally, commodity OSes generally do not provide robust recoverability capabilities to address failure situations.

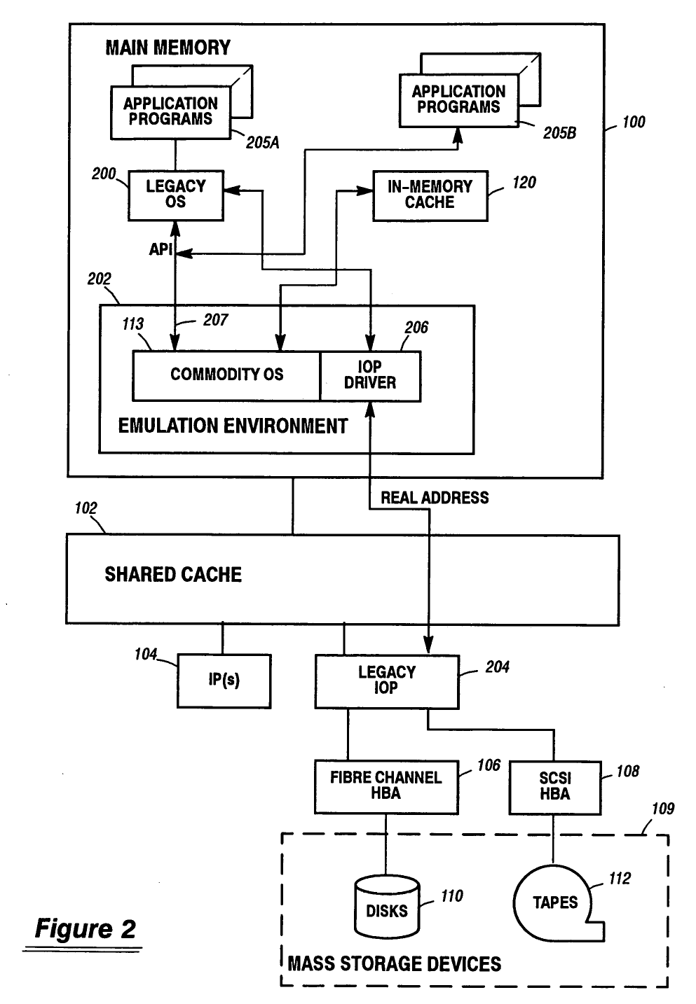

FIG. 2 is a block diagram of a data processing system according to the current invention. In FIG. 2, elements similar to those of FIG. 1 are assigned like numeric designators. According to the illustrated system, a legacy OS 200 of the type that is generally associated with mainframe systems is loaded into main memory 100. This legacy OS, which may be the 2200 OS commercially available from Unisys Corporation, is adapted to execute directly on a “legacy platform”, which may be a mainframe system such as a 2200 or an A-series data processing system commercially available from the Unisys Corporation. Alternatively, this legacy platform may be some other enterprise-type environment that provides the security, data protection, and recovery mechanisms generally associated with mainframe systems. Such mechanisms are provided to prevent unintentional deletions or updates to data stored on mass storage devices 109. These mechanisms also ensure that the data is maintained in a coherent state.

In one embodiment, legacy OS 200 may be implemented using a different machine instruction set (hereinafter, “legacy instruction set”, or “legacy instructions”) than that which is native to IP(s) 104. This legacy instruction set is the instruction set which is executed by the IPs of a legacy platform on which the legacy OS is intended to operate. In this embodiment, the legacy instruction set used to implement legacy OS is emulated by an emulation environment 202. The details associated with the operation of emulation environment 202 are largely beyond the scope of this disclosure. More information regarding the operation of this environment may be found in the commonly-assigned U.S. patent application entitled “System and Method for Synchronizing Memory Management Functions of Two Disparate Operating Systems”, attorney docket number RA-5827, filed on even date herewith.

In the illustrated adaptation, legacy OS 200 communicates with commodity OS 113 via an application program interface (API) 207. As is known in the art, an API is an interface that a computer system, library, or application provides to allow requests for services to be made of it by other computer programs and/or to allow data to be exchanged between the two entities. In one embodiment, the legacy OS 200 uses the same API 207 to obtain services from the commodity OS as any other software application program, such as one of APs 205B, would employ. Thus, the legacy OS appears to the commodity OS as just another software application that is requesting the commodity OS′ services.

One type of service the legacy OS 200 may request involves memory allocation. In response to such a call, the commodity OS 113 returns a virtual address to the legacy OS that points to the newly-allocated block of memory of the requested size. This will be described further below.

Emulation environment 202 may include any type of emulator that is known in the art. For instance, the emulator may be an interpretive emulation system that employs an interpreter to decode each legacy computer instruction, or groups of legacy instructions. After one or more instructions are decoded, a call is made to one or more routines that are written in “native mode” instructions that execute directly on IP(s) 104. Such routines emulate each of the operations that would have been performed if the corresponding legacy instruction were being executed on a legacy platform.

Another emulation approach utilizes a compiler to analyze the object code of legacy OS 200 and thereby convert this code from the legacy instructions into a set of native mode instructions that execute on IP(s) 104. The legacy OS then executes directly on IP(s) without any run-time aid of emulation environment 202. These, and/or other types of emulation techniques, may be used to emulate legacy OS 200 in an embodiment wherein OS 200 is written in an instruction language other than that which is native to IP(s) 104.

Legacy OS 200 is adapted to communicate directly with various legacy I/O Processors (IOPs) such as legacy IOP 204, which includes I/O hardware of a type typically found on a legacy platform. Legacy IOP 204 provides an interface between main memory 100 and the HBAs such as fibre channel HBA 106 and SCSI HBA 108. Legacy OS 200 includes data protection and other security features that ensures that I/O operations initiated by the legacy OS will maintain the data stored within mass storage devices 109 in a coherent state. The legacy OS also has sophisticated protection mechanisms in place to guard against unintentional or unauthorized data deletions or updates.

Commodity OS 113 is not adapted to initiate I/O operations using legacy IOP 204. During system initialization, commodity OS 113 will determine that some unidentified type of hardware device (i.e., legacy IOP 204) is coupled to the system and will cause the appropriate driver to be loaded, which in this example is shown as IOP driver 206. This IOP driver 206 provides an interface that allows the commodity OS to communicate in a limited fashion with the legacy IOP 204. However, IOP driver 206 does not allow the commodity OS 113 to communicate directly with the HBAs. In fact, the legacy IOP 204 hides the existence of the HBAs from the commodity OS. As a result, the commodity OS 113 will not attempt to perform I/O operations to/from mass storage devices 109. This protects the data from any unauthorized inadvertent and/or malicious update activities that may be initiated via commodity OS 113.

According to the configuration of FIG. 2, all I/O operations that involve “legacy data” are initiated via legacy OS 200 rather than commodity OS 113. In this context, legacy data is data that has been moved from a legacy platform to a commodity platform, and is of a type that requires heightened levels of security and recoverability. For purposes of the remaining discussion, it will be assumed that mass storage devices 109 contain legacy data.

Legacy OS may initiate an I/O operation to transfer legacy data on behalf of application programs (APs) 205A. For instance, APs 205A may make a request to legacy OS 200 to read data from, or write data to, mass storage devices 109. When this occurs, the requesting one of APs 205A provides one or more addresses to data buffers in main memory to which, or from which, the data will be transferred.

When one of APs 205A is going to transfer legacy data, it must first acquire one or more data buffers in main memory from which, or to which, the transfer will occur. To do this, the AP makes a call via legacy OS 200 to commodity OS 113. Commodity OS allocates the one or more buffers and returns one or more addresses to the requesting AP via legacy OS 200. These addresses are in virtual address space. That is, the addresses are not physical addresses that may be used to address physical memory. This is because while commodity OS 113 has access to physical memory, legacy OS and APs 205A only have access to virtual address space. The significance of this is described further below.

Next, legacy OS 200 creates a description of the I/O operation being requested. This description will be used by the legacy IOP 204 to complete that operation. To do this, legacy OS 200 makes one or more requests to commodity OS 113 requesting commodity OS to allocate memory space for this description. Commodity OS 113 responds by obtaining an area in virtual address space and returning the starting address of this acquired area to the legacy OS. This area is referred to as buffer descriptor (BD) buffer.

The BD buffer will be used by the legacy OS 200 to create a description of the I/O operation to be performed. This description is referred to as a request packet (not shown in FIG. 2). The request packet includes the address(es) of the data buffer(s) in main memory to which, or from which, the data will be transferred.

In one embodiment, a single I/O operation may be broken into multiple I/O sub-operations. This occurs, for instance, if a single I/O read or write request involves transfers to multiple non-contiguous blocks of memory in virtual address space. For example, a write request may transfer a first block of data from address 1000 in virtual address space, and a second block of data from address 10000 in virtual address space, with both blocks being stored to the same file in mass storage. Each block of data will be described as a separate I/O sub-operation that retrieves a specified amount of data from a location of main memory and transfers that data to a specified address of a mass storage device.

Because a given I/O operation may be broken up into many sub-operations, the description of the operation can be very large such that the BD buffer may occupy a large amount of space. In some cases, the legacy OS 200 may even have to request allocation of one or more additional areas, or BD buffers, in virtual address space to hold the entire description of the I/O operation. Thus, while the following description generally discusses a request packet as being created within a single BD buffer for ease of reference, it should be understood that in some cases, multiple BD buffers are used for this purpose. When multiple BD buffers are used to store a request packet, the BD buffers are linked together as a linked list via pointers stored in control areas of each BD buffer.

Sometime during or after building of the request packet, the BD buffer obtained to describe the I/O operation must be “nailed” in memory. This refers to the process of ensuring that the buffer is resident in, and ineligible to be paged out of, main memory 100. This is necessary so that the description of the I/O operation is not paged out of memory while that I/O operation is occurring. The time and manner in which the buffer is nailed is implementation-specific, and will be described further below with the description of each implementation.

After legacy OS 200 has completed the building of the packet in the BD buffer in main memory, the legacy OS indicates to legacy IOP 204 that the packet is available for processing. This may be accomplished by the legacy OS 200 setting a designator in an initiation queue to a predetermined state, as will be discussed further below. The IOP driver 206 is polling this designator, and thereby determines that a request packet is available for processing. In other embodiments, interrupts or messaging techniques may be used to communicate the availability of this new request packet.

When the new request packet gains priority, IOP driver 206 performs some pre-processing on this packet. In one embodiment, this pre-processing is necessary because of the differences between the way commodity OS 113 and legacy OS 200 addresses memory. The types of pre-processing activities that are needed are specific to the embodiment. Each embodiment will be described in detail below.

After the IOP driver 206 completes the pre-processing activities, IOP driver 206 provides an indication to legacy IOP 204 to initiate the I/O operation described by the packet. An I/O operation may involve reading data from the one or more specified data buffers in main memory 100 and storing this data to one or more of the mass storage devices 109. Conversely, an I/O operation may involve retrieving data from mass storage devices 109 and writing that data to one or more data buffers in main memory 100.

When the I/O operation is completed, legacy IOP 204 generates a status packet in main memory 100 that is used to indicate to legacy OS 200 whether the I/O operation completed successfully. If the operation did not complete successfully, this status packet will contain an address within the BD buffer that will identify an I/O sub-operation that was associated with the failure. This address is used by the legacy OS 200 to determine where the I/O operation failed.

The status packet may further include a count value. In one scenario, this count value indicates how much data was transferred to, or from, a particular data buffer in main memory before a failure occurred. Alternatively, this count may indicate how much data was transferred to a data buffer at the time an end-of-storage designation (e.g., an “end-of-tape” mark) in mass storage was encountered. If an error occurred, the legacy OS 200 may then retry the I/O operation, or perform some other predetermined recovery action.

As noted above, legacy OS 200 includes protection mechanisms that ensure data is maintained within mass storage devices 109 in a coherent manner such that older data never overwrites more recent updates. Additionally, the legacy OS generally provides more rigorous safeguards to guard against the unauthorized deletion and modification of, or access to, the data on mass storage devices. Moreover, when a user initiates certain actions such as the deletion of data from a shell prompt, legacy OS will provide a warning message that allows a user to reconsider the pending operation. Commodity OS 113 may not provide this type of warning message.

The foregoing features become even more important when the system is being operated by users that are more familiar with legacy OS 200 than commodity OS 113. In situations wherein legacy data from a mainframe system has been transported to a commodity-type data processing environment, a user of the legacy data may not be familiar with a cryptic commodity OS such as UNIX, making it more likely unintended operations could corrupt data. The current invention addresses these issues by providing the legacy OS 200 on the commodity platform of FIG. 2 in the above-described manner. This allows a user to initiate and control I/O operations using commands to the legacy OS that are familiar to the user.

As discussed above, several embodiments of the system are disclosed. In one polling embodiment, no modifications are needed to legacy OS 200 and legacy IOP 204 to allow these entities to execute on the commodity platform shown in FIG. 2. This is because the infrastructure required to support their execution is provided entirely by IOP driver 206. In several other embodiments, some changes are made to legacy OS 200 and legacy IOP 206 to facilitate faster execution of I/O operations. Each of these embodiments is considered in turn below.

### II. Polling Mode

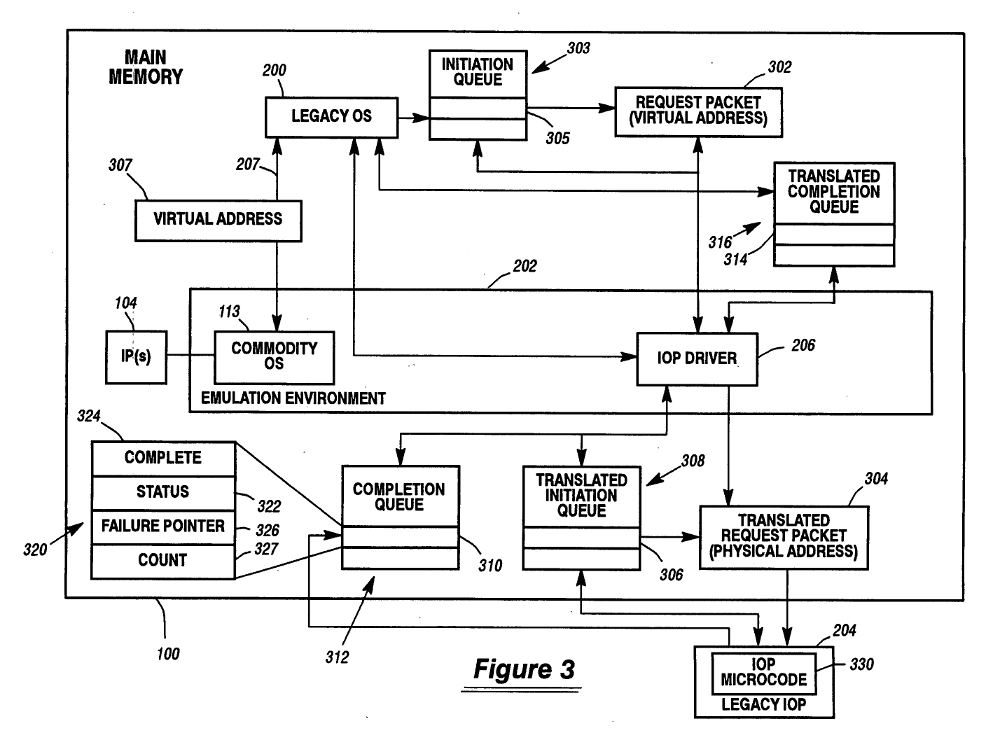

According to one embodiment of the invention, legacy OS 200 and commodity OS 113 conform to different memory management requirements. To simplify API 207 and avoid changes to legacy OS 200 and legacy IOP 204, a polling mode is provided wherein much of these differences are “hidden” from the legacy OS 200 and legacy IOP 204 by processing activities performed by IOP driver 206. Several of these processing activities are described further in regards to FIG. 3.

FIG. 3 is a block diagram that illustrates the memory constructs used to support I/O operations according to the current invention. In FIG. 3, elements that are similar to those in FIG. 2 are labeled using like numeric designators.

Within the environment of FIG. 3, legacy OS 200 may make a determination that an I/O operation is be initiated either on its own behalf or on behalf of one of APs 205A. In either case, legacy OS makes an initial request to commodity OS 113 to obtain a BD buffer in main memory in which to create the request packet. In response to this request, commodity OS 113 returns an address to an allocated area in memory. This memory area resides in virtual address space and is used as the BD buffer.

When executing on its native legacy platform, any memory allocation request made by legacy OS 200 will return a physical, rather than a virtual, address. Therefore, in one embodiment, legacy OS “thinks” that the address returned for use as the BD buffer is a physical, rather than a virtual, address. This affects the way the BD buffer is processed, as will be discussed further below.

After legacy OS 200 receives the address of the allocated memory that will be used as the BD buffer, legacy OS 200 builds a request packet in this buffer. This request packet will describe the type of I/O operation to be performed (e.g., read versus write), as well as how that I/O operation is to be performed.

For reasons discussed above, in one embodiment the request packet describes multiple sub-operations. For instance, assume the I/O operation is to read a large amount of data from an identified one of tapes 112 (FIGS. 1 and 2). Some of this data is stored to a first data buffer in main memory, a different portion of the data is stored to a different data buffer in memory, and so on. Each data transfer to a different data buffer will be described as a different sub-operation that is contained within a different entry of the request packet.

Each entry of a request packet is referred to as a Buffer Descriptor (BD). Each entry, or BD, describes the size and starting address of the buffer that has been allocated for the I/O sub-operation associated with the BD. One implementation uses a BD that conforms to the buffer descriptor format employed by legacy OS 200 when operating on its native legacy system.

As is the case with the address of the BD buffer itself, each data buffer address stored within each BD is a virtual, rather than a physical, address. The legacy OS 200 is not “aware” that these data buffer addresses are virtual, as will be described further below.

During the process of building the request packet 302, legacy OS 200 also builds a respective entry 305 on an initiation queue 303 that points to the request packet in virtual address space. The initiation queue is a dynamic queue in main memory 100 that is used by legacy OS 200 to indicate when I/O request packets are available for processing. When legacy OS 200 completes request packet creation, legacy OS sets an appropriate designator in entry 305 of the initiation queue 303. This indicates that the associated request packet is ready for processing.

If legacy OS 200 were operating on a legacy platform, legacy IOP 204 would be monitoring the designator in the initiation queue to determine when request packet 302 is ready for processing. Legacy IOP 204 would then process this packet directly without use of any intermediate translating step. However, two characteristics of the current system make some translation necessary before legacy IOP may process the packet. First, the request packet 302 resides in virtual address space. In other words, the address contained in entry 305 is a virtual address. Moreover, all addresses stored within the BD buffer that point to data buffers are virtual addresses, as will be described further below. These addresses cannot be used directly by the legacy IOP 204, which expects all addresses to be physical addresses to physical memory devices. Thus, translation is required to translate all virtual addresses to physical addresses.

In addition to the foregoing, none of the memory allocated for use in storing the request packet has been nailed in main memory. Processing is needed to nail this memory before the I/O operation can be initiated. As discussed above, nailing refers to the process of ensuring that the allocated pages are resident in, and ineligible to be paged out of, main memory 100. Nailing of memory space is necessary so that the pages are not transferred to one of mass storage devices 109 during an I/O operation that is currently using those pages.

In view of the foregoing, when the designator bit of entry 305 is set, IOP driver 206 nails all of the memory used for the BD buffer so that it is not paged out of memory while that buffer is being used during the I/O operation. The IOP driver also translates each virtual address that is stored within the request packet into one or more physical addresses that map to the virtual address. To accomplish this address translation, IOP driver 206 calls various standard memory management utilities of commodity OS 113. These utilities convert virtual addresses into physical addresses. The physical addresses that are returned by the commodity OS 113 in response to these calls are used by IOP driver 206 to create a translated request packet 304. In one embodiment, each BD of the original request packet will be translated into multiple BDs of the translated request packet 304. This is discussed in detail below.

As IOP driver is creating the translated request packet 304, it places a corresponding entry 306 on a translated initiation queue 308. The translated initiation queue 308 is a queue of the same format as initiation queue 303. It is used to communicate to legacy IOP 204 when a new translated request packet is available for processing. In particular, entry 306 contains a physical address pointing to the translated request packet 304 in physical memory.

When IOP driver 206 completes creation of translated request packet 304, IOP driver sets a designator in the corresponding queue entry 306 to indicate that the translated packet is ready for legacy IOP 204 to process. Assuming that legacy IOP 204 is ready to process another request packet, legacy IOP 204 will be polling the designator in queue entry 306 and will thereby determine another packet is ready for processing. Legacy IOP 204 may then access the translated request packet and complete the I/O operation, as will be discussed further below.

When legacy IOP 204 completes the I/O operation described by translated request packet 304, it places an entry 310 on completion queue 312. This entry is in the format shown in block 320. It includes status 322 to indicate whether the I/O operation completed successfully. If the operation did not complete successfully, the entry will indicate via failure pointer 326 which sub-operation of the request packet was associated with the failure. Alternatively, the failure pointer 326 may indicate that one of the I/O sub-operations transferred less data than was expected.

Finally, entry 310 may include a count 327 provided to indicate how much data was stored to the buffer associated with the failure pointer 326. This count may indicate how much data was transferred to/from an associated buffer before an error occurred. Alternatively, it may indicate the amount of data transferred to a buffer if the buffer was not filled. For instance, assume data is being transferred from tape to a buffer in main memory 100. If an end-of-tape marker is encountered on the tape before the buffer is full, count 327 will indicate the buffer location of the last received word from tape.

If legacy IOP 204 were operating on a legacy platform, completion queue 312 would be accessed directly by legacy OS 200, which would then perform any processing to complete the I/O operation. If a failure occurred, legacy OS 200 may re-initiate the failing operation or perform some other type of recovery action.

In the type of system shown in FIG. 3, completion queue 312 contains physical, not virtual, addresses. For instance, failure pointer 326 will be a pointer to a physical address within translated request packet 304. Since legacy OS 200 is operating in virtual address space, it cannot properly process queue entry 310. Therefore, IOP driver 206 manipulates entry 310 to create entry 314 of translated completion queue 316. This queue entry 314 contains addresses in virtual address space, as is required by legacy OS 200 when legacy OS is operating on a commodity platform. When entry 314 is completed, IOP driver 206 sets a designator in the queue entry to indicate to legacy OS 200 that it may begin processing the queue entry and thereby complete execution of the I/O operation.

As is apparent from the foregoing description, IOP driver 206 provides a translation mechanism between the virtual address environment in which legacy OS 200 is operating and the physical address environment in which legacy IOP 204 is operating. On a legacy platform, this translation process is unnecessary because both legacy OS 200 and legacy IOP 204 are operating in physical address space with the same addressing requirements.

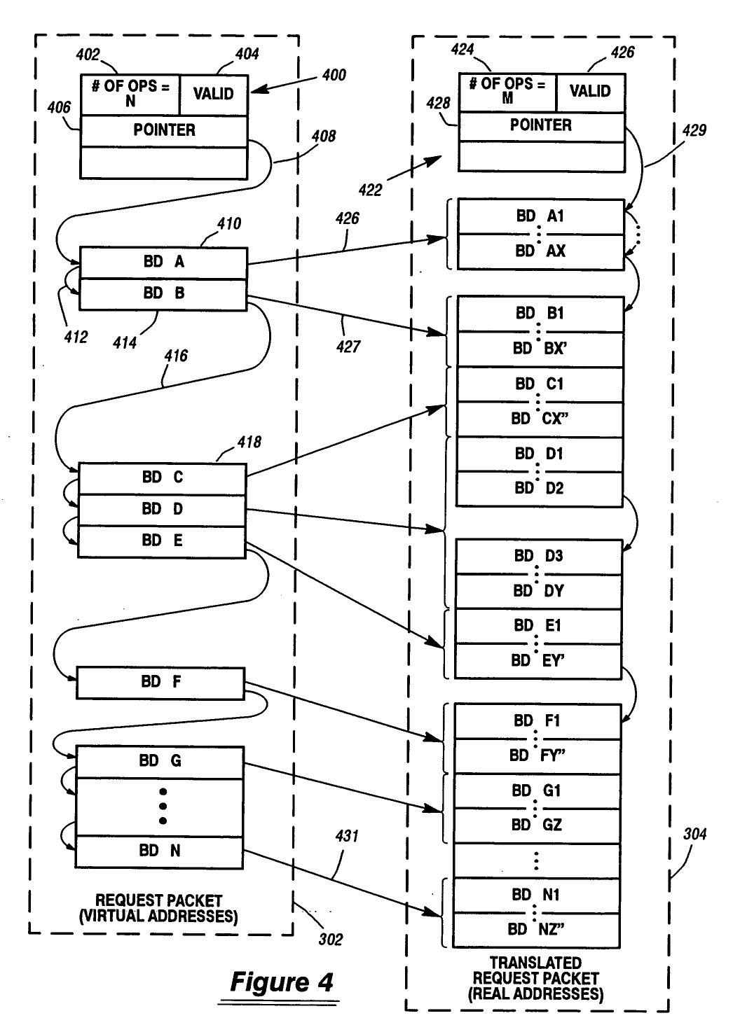

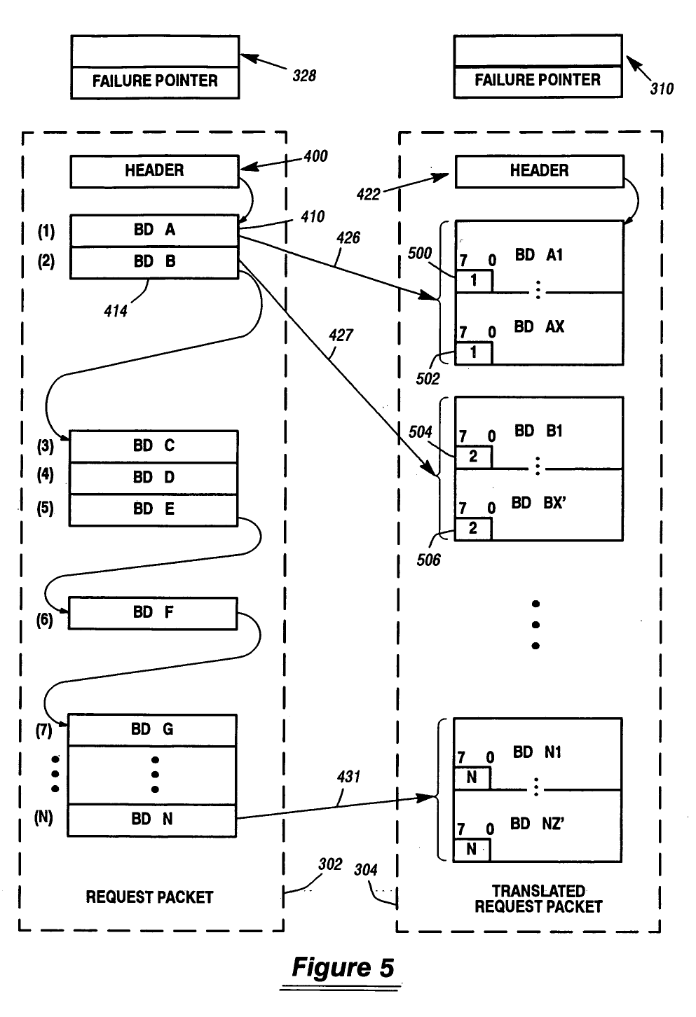

The specific translation mechanisms being performed by IOP driver 206 are discussed further below in reference to FIGS. 4 and 5.

FIG. 4 is a block diagram illustrating the processing performed by one embodiment of IOP driver 206 to translate request packet 302 (shown dashed) into translated request packet 304 (shown dashed). Request packet 302 contains a header block 400 that provides general information about the I/O operation that is to be performed. For example, the header contains a valid field 404 which is set to indicate whether the request packet includes valid information, and a pointer field 406 that stores a pointer 408 to the first BD in the packet.

This header block also contains a field 402 that indicates the number of I/O sub-operations described by the packet, wherein a sub-operation is a portion of a larger I/O operation. For instance, assume an I/O operation involves reading 128K bytes of data from tape to main memory 100. This I/O operation may be divided into multiple sub-operations, each involving reading a respective 32K-byte portion of this data to a respectively different buffer in virtual address space. In the current example, the number of sub-operations in request packet 302 is “N”.

Each I/O sub-operation is described by a respective buffer descriptor (BD). For example, if a sub-operation involves reading a 32K-byte portion of data from a respective data buffer in virtual address space, the BD will store the virtual address for this data buffer. The BD also describes the amount of data being transferred in this sub-operation.

As mentioned above, the request packet 302 of the current example describes N I/O sub-operations, each described by a corresponding BD A-N. In one embodiment, these BDs are arranged in a linked list. That is, BD A 410 includes a pointer 412 to BD B 414. Likewise, BD B 414 stores a pointer 416 to BD C 418, and so on. These BDs are not necessarily arranged in consecutive addresses in virtual address space. This may happen, for instance, if multiple BD buffers were required to store the request packet, as was discussed above.

IOP driver 206 translates request packet 302 into a format that may be used by legacy IOP 204 to perform successful I/O operations. As discussed above, in one embodiment, IOP driver 206 performs this translation by requesting another buffer from commodity OS. The IOP driver nails this buffer in memory, and then uses this buffer to create a second translated request packet 304 elsewhere in main memory 100.

The translated request packet 304 contains a header 422 that is similar to header 400 of request packet 302. This header 422 contains field 424 indicating the number of I/O sub-operations that will be performed. Field 426 is set to a predetermined value to indicate the packet contains valid information. Finally, pointer field 428 points to the first BD in the translated packet.

As may be noted by FIG. 4, the number of I/O sub-operations described by the translated request packet 304 (exemplified as “M” in FIG. 4) is not necessarily the same as that described by request packet 302. This relates to the fact that memory allocation restrictions may be different in a commodity platform as compared to those of a legacy platform. In particular, in many commodity systems such as PCs, the maximum size of allocated physical memory (that is, the page size) is 4K bytes. This is a hardware restriction set by many off-the-shelf processors, such as processors available from Intel Corporation and Advanced Micro Devices, Inc. In contrast, the maximum page size within a legacy platform may be considerably larger. For instance, a page size of a legacy platform to which legacy OS 200 is native is 32K bytes.

As a result of the foregoing, a buffer that resides within 32K contiguous bytes of virtual address space may be stored in eight or more non-contiguous blocks in physical memory, with each block being no more than 4K bytes in size. Therefore, while legacy OS 200 views a BD within request packet 302 as representing a single I/O sub-operation to a contiguous block of memory, that BD may actually represent eight or more I/O sub-operations to eight or more respectively different non-contiguous blocks of physical memory.

According to techniques known in the art, commodity OS 113 tracks the physical memory allocated to a given buffer in virtual address space using memory mapping tables. These tables may resolve a block within virtual address space into multiple non-contiguous blocks of physical memory. That is, each virtual address within a BD may be associated with multiple addresses in physical memory.

The information maintained by the memory mapping tables of commodity OS 113 are used by IOP driver 206 to build translated request packet 304 as follows. IOP driver 206 uses pointer 408 of request packet 302 to obtain the first BD in the request packet. Each such BD stores a virtual address pointing to the data buffer that has been allocated for the I/O operation. IOP driver makes a request to a utility of commodity OS 113 that accesses the memory mapping table for this virtual address. If the call is successful, commodity OS returns an array of page descriptors that provides the starting physical addresses of the pages in physical memory that have been allocated to the buffer in virtual address space.

In one embodiment, IOP driver 206 may make calls to a standard utility of commodity OS 113 to nail each of the identified physical pages of the data buffer in main memory. As discussed above, this involves ensuring that each allocated page of the data buffer is resident in memory and is designated as being ineligible for paging out of main memory 100 until it is no longer nailed. In another embodiment, it is the responsibility of the requesting one of APs 205A to nail the data buffers before initiating the I/O operation.

IOP driver 206 next creates a BD in the translated request packet 304 for each page of physical memory that has been allocated to the data buffer in virtual address space. IOP driver 206 creates each such BD in the format that is expected by legacy IOP 204, which is the same format used by the BDs of request packet 302. Each BD in translated request packet 304 includes a physical address in physical address space and the size of the data buffer in physical memory.

As may be appreciated from the foregoing, a single BD within request packet 302 may be translated into many BDs within translated request packet 304. This is true because in one embodiment, each BD in request packet 302 represents a buffer that, from the legacy OS′ viewpoint, represents 32K bytes of contiguous storage space in physical memory. However, that 32K-bytes of storage space actually resides in virtual, not physical, address space. The physical memory allocated to this 32K-byte buffer is in 4K-byte blocks which, in all likelihood, are not contiguous in physical memory. Thus, for instance, BD A 410 of request packet 302 is translated into BDs A1-AX, as shown by arrow 426. This is true for each of BDs A-N of request packet 302.

The foregoing describes how a contiguous block of memory in virtual address space that has been allocated for use as a data buffer may actually reside in multiple blocks of physical memory. These physical memory blocks may, or may not, be contiguous. In a similar manner, a contiguous block of memory in virtual address space that stores all, or a portion of all, of request packet 302 may reside in multiple non-contiguous blocks of physical memory. That is, when legacy OS 200 obtains a BD buffer, that buffer appears to the legacy OS to be a block of contiguous storage space. However, it may actually map to multiple non-contiguous blocks of physical memory. As a result, when the IOP driver 206 accesses a BD buffer in virtual address space, it must use the virtual-to-physical address translation capabilities of commodity OS 110 to locate the one or more corresponding areas in physical memory that correspond to the single BD buffer in virtual address space. The multiple physical memory areas that map to a single BD buffer in virtual address space are represented by the non-contiguous blocks of BDs that are linked via pointers such as pointers 408, 416, and so on of FIG. 4.

Returning to a discussion of the translated request packet 304, in one embodiment, the BDs of this packet are arranged in a linked list. Pointer field 428 of header 422 contains a pointer 429, which is a physical address. This pointer identifies the address in physical memory that stores the first BD in the linked list, which is shown as BD A1. This BD points to the next BD, and so on. The BDs need not be stored in contiguous physical memory. For instance, BDs A1-AX need not be contiguous with BDs B1-BX′.

After IOP driver 206 has completed building translated request packet 304, IOP driver 206 sets valid designator 426 to the appropriate value to indicate that the packet contains valid data. IOP driver further sets the designator in entry 308 of translated initiation queue 308 (FIG. 3) to indicate to legacy IOP 204 that packet 304 is ready for processing. From the view point of legacy IOP 204, the packet was provided directly from legacy OS 200, and legacy IOP has no visibility to the pre-processing activities performed by IOP driver 206.

Legacy IOP 204 processes translated request packet 304 in the same manner as it would if legacy IOP were operating on a legacy platform. That is, legacy IOP 204 accesses a predetermined location in physical memory to locate translated initiation queue 308. Legacy IOP 204 thereby retrieves an entry that is ready for processing based on a designator bit in that entry. From that entry, it retrieves a pointer to the corresponding translated request packet 304. Legacy IOP 204 processes each BD within this packet in turn, performing the necessary I/O sub-operation to, or from, the described buffer in physical address space of main memory 100.

When legacy IOP 204 completes all I/O sub-operations described by translated request packet, legacy IOP 204 builds an entry 310 in completion queue 312 (FIG. 3), as described above. As discussed above, in one implementation, the entry takes the form shown in block 320, including a completion designator 324 to indicate that creation of the entry is complete.

When operating on a legacy hardware platform, the setting of the completion designator 324 of an entry on the completion queue 312 indicates to legacy OS 200 that it may retrieve the entry and begin any post-processing activities needed to finish the I/O request. However, as discussed above, legacy OS 200 does not have visibility to completion queue 312. Therefore, IOP driver 206 determines that the completion designator 324 of entry 310 has been set to indicate that the I/O operation described by the packet is complete. In response, IOP driver 206 builds an entry 314 of translated completion queue 316 that is visible to legacy OS 200. In one embodiment, this occurs as follows.

First, IOP driver 206 checks the status field 322 of entry 310 to determine whether an error occurred on the operations described by translated request packet 304. If not, IOP driver sets the corresponding status field of entry 314 to indicate that no I/O error occurred. IOP driver 206 then sets the completion designator 324 of entry 314 to indicate the I/O operation is completed. This causes legacy OS 200 to perform the post-processing activities needed to conclude I/O processing.

In some cases, IOP driver may determine from the status field 322 of entry 310 that an error occurred during one of the I/O sub-operations described by translated request packet 304. IOP driver must therefore determine which BD is associated with the error. This is accomplished by retrieving the contents of failure pointer field 326 from entry 310. The retrieved pointer points to the BD of translated request packet 304 that was being processed by legacy IOP 204 when the failure occurred. The count field 327 will then indicate how much data was transferred prior to this failure.

Since legacy OS 200 does not have visibility into translated request packet 304, IOP driver 206 must translate a failure pointer 326 into something that will be meaningful to legacy OS 200. In other words, IOP driver must generate a corresponding pointer that points to one of the BDs within the original request packet 302. In this way, legacy OS 200 can identify which I/O sub-operation was occurring when the error occurred. Thus, for example, if the failure pointer of entry 310 points to any one of BDs A1-AX, IOP driver 206 must convert this pointer into a pointer that identifies BD A 410 of original request packet 302. Similarly, if the failure pointer identifies any one of BDs B1-BX′, the pointer must be converted to identify BD B of the original request packet, and so on.

One very simple way to accomplish the above-described objective is to store the address of BD A 410 in an unused field of each of the BDs A1-AX, and so on. This address can be retrieved by IOP driver 206 to make the necessary translation if an error occurs. However, each BD is stored in main memory, which in one embodiment is identified using a 72-bit memory address. Moreover, the BDs are created according to a predetermined format that is understood by both legacy OS 200 and legacy IOP 204. In one embodiment, this format does not provide an unused field of the necessary size that can be used to store this address. Therefore, some other mechanism is needed to provide for this address translation. One embodiment of this mechanism is described in regard to FIG. 5.

FIG. 5 is block diagram illustrating one method of converting a buffer descriptor pointer for translated request packet 304 into a buffer descriptor pointer for request packet 302. As discussed above, it is undesirable to alter the predetermined format of the BDs, since changing this format would require making modifications to legacy OS 200 and legacy IOP 204. The format of the BDs does contain one unused field that is large enough to store a count for the maximum allowable number of BDs that can be included in a linked list. Thus if the linked list of BDs can be, at most, “N” BDs long, the unused field is large enough to store the number “N”.

In a translated request packet 304, the unused field is assigned to store an encoded label that identifies a corresponding BD within request packet 302. For instance, the label field 500 of BD A1 may store “1” to indicate it is associated with BD A, which is the first BD in the linked list of request packet 302. In a like manner, each label field 502 of BDs A2-AX will store a “1”. Similarly, label fields 504-506 of BDs B1-BX′ each stores a “2” to identify BD B, which is the second BD in the linked list of packet 302, and so on as shown in FIG. 5.

According to one embodiment of the invention, IOP driver 206 sets the label fields to the appropriate labels during creation of translated request packet 304 as follows. As IOP driver 206 is processing request packet 302 to create translated request packet 304, IOP driver maintains a count of the encountered BDs of the request packet 302. The current count is then stored to each BD in translated request packet that corresponds to the current BD of request packet 302. For instance, when IOP driver 206 is processing BD A 410, the count is set to “one”. This is stored within label field for each of BDs A1-AX, and so on.

The contents of the label fields are used by IOP driver 206 to map a failure pointer from an entry in completion queue 312 into a failure pointer for translated completion queue 316. That is, IOP driver 206 uses the address stored in the failure pointer 326 of an entry in completion queue to locate a BD within translated request packet 304. IOP driver retrieves the contents of the label field for this located BD. The IOP driver then accesses the predetermined address at which the header 400 of request packet 302 resides. From there, the IOP driver retrieves the pointer 408 to the first BD (FIG. 4). IOP driver begins traversing the linked list of BDs in request packet 302, incrementing a count as it goes. For instance, when IOP driver encounters BD A, the count is set to “one”. When IOP driver traverses to BD B 414, the count is incremented to “two”, and so on.

When the count is incremented to the retrieved value from the referenced label field of translated request packet 304, the corresponding BD from request packet 302 has been located. IOP driver 206 then stores the virtual address for this BD in failure pointer field 326 of the corresponding entry in translated completion queue 316. IOP driver further copies the count field 327 to the new entry within the translated completion queue. Finally, IOP driver 206 sets the completion designator 324 of that entry in the translated completion queue to indicate to legacy OS 200 that the I/O operation(s) described by request packet 302 have been completed.

Operations similar to those described above are taken if a buffer was not completely filled during an I/O operation. That is, an I/O operation may have completed successfully, but because an end-of-tape marker or some other similar mechanism was encountered, the buffer in main memory that was receiving the I/O data may be only partially filled. This is indicated by status field 322. In this case, the pointer of field 326 identifies the BD within the translated request packet that was being processed when this occurred, and count field 327 indicates the last word of the main memory buffer that contains valid transferred data. IOP driver uses the labels described above to create a corresponding status entry in translated completion queue 316. The newly-created entry is in the format shown in block 320, and has the same count and status field contents as the original status entry. The contents of pointer field 326 points to a BD within request packet 302. Legacy OS 200 may interpret this status entry to determine the location of valid transferred data.

The entry within translated completion queue 316 allows legacy OS 200 to perform the necessary post-processing activities required to finish the I/O operations. If an error occurred as indicated by field 322 of the entry, legacy OS may retry the failing operation, or perform some other recovery action. Legacy OS is capable of performing sophisticated recovery operations that are not available within commodity-type platforms. The current invention provides the capability of providing these types of failure recovery features within a commodity environment.

The polling embodiment described above provides a mechanism to implement I/O operations using a legacy OS 200 and a legacy IOP 204 on a commodity platform. This provides the enhanced security, recoverability, and protection mechanisms generally only available on legacy platforms on a low-end data processing system. These benefits are available without requiring any modifications to legacy OS 200 and legacy IOP 204.

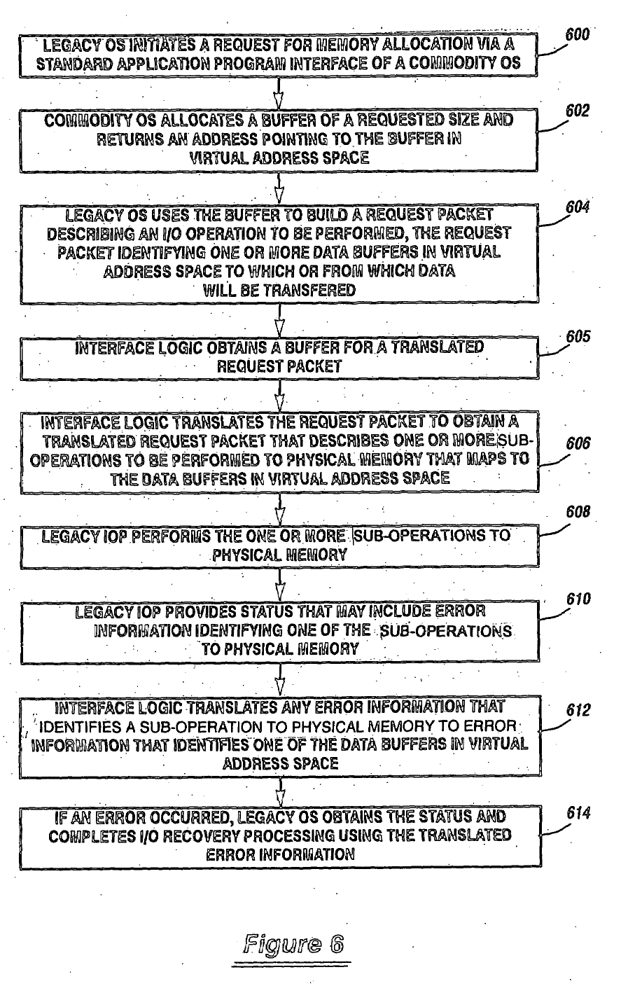

FIG. 6 is a flow diagram of one method of performing I/O operations according to the polling embodiment of the invention described above. First, legacy OS 200 initiates a request for memory allocation. This request is issued via a standard API of commodity OS 113 (600). Commodity OS 113 allocates the requested amount of memory and returns an address pointing to the allocated buffer in virtual address space (602). The legacy OS uses the allocated memory as a BD buffer in which to build a request packet that describes an I/O operation to be performed to one or more data buffers in virtual address space (604). This request packet will identify the one or more data buffers in virtual address space to which, or from which, data will be transferred, as was described above.

Next, interface logic, which in one embodiment resides within the IOP driver, obtains a buffer for use in storing a translated request packet (605). This buffer may be obtained via a call to the commodity OS 113. The interface logic then translates the original request packet to obtain a translated request packet that will be stored within this newly-acquired buffer (606). The translated request packet describes one or more I/O sub-operations. Each of these sub-operations of the translated request packet will be performed to the physical memory that maps to the data buffers allocated in virtual address space.

After the translated packet is created, a legacy IOP performs each of the one or more I/O sub-operations to the physical memory that is described by the translated request packet (608). The legacy IOP then provides status describing how these I/O sub-operations completed. This status may identify an error that occurred on one of the sub-operations within the physical memory (610). Interface logic, which in this case resides within the IOP driver, translates any identified error that may have occurred on one of the I/O sub-operations. This translation converts the error from one that identifies an I/O sub-operation (and hence a data buffer) in physical address space into an error that identifies one of the data buffers in virtual address space (612). As discussed above, the translated error information may now identify a BD within the original request packet that is associated with the error.

If an error occurs, the legacy OS uses the status and any translated error information to perform recovery operations within virtual address space (614). As previously described, recovery operations performed by the legacy OS are of a type typically only available within legacy environments. According to the current invention, these recovery operations are made available on a commodity platform.

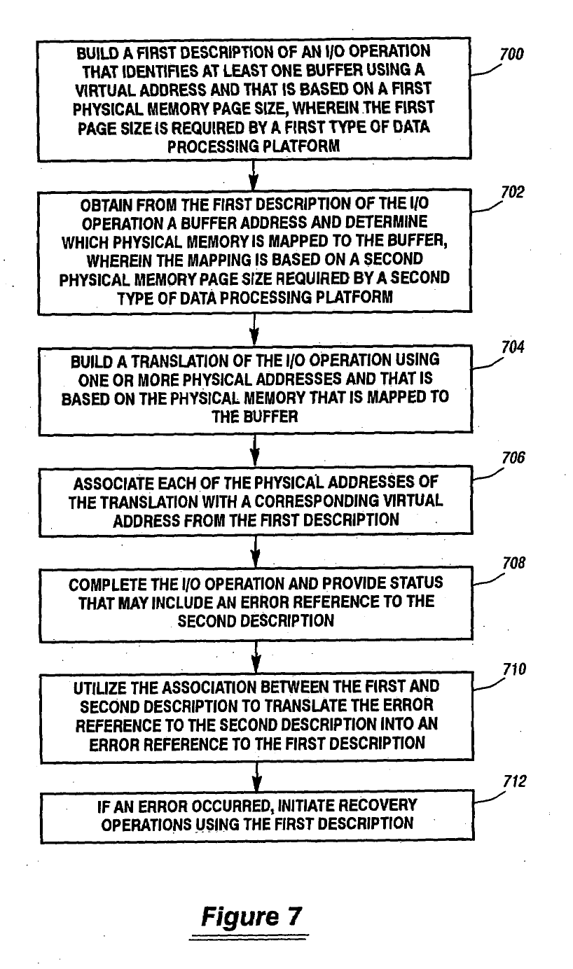

FIG. 6 describes a general method of translating a request packet according to the current invention. This method does not describe the specific mechanism used in FIG. 5 to associate a BD of the original request packet 302 with a BD of the translated request packet 304. The mechanism of using labels to associate a BD of a translated request packet with that of an original request packet is discussed in more detail in regards to the method of FIG. 7.

FIG. 7 is a flow diagram that describes one method of translating a request packet according to another embodiment of the invention. A first description of an I/O operation is created that identifies at least one data buffer using a virtual address and that is based on a first physical memory page size, wherein the first page size is required by a first type of data processing platform (700).

In the embodiment described above, step 700 is performed by creating at least one BD that is included in the request packet built by the legacy OS. Each BD contains a virtual address that is sized according to the 32K-byte maximum page size required by a legacy platform. According to this restriction, if an I/O operation is needed that requires a buffer space that is larger than 32K bytes, legacy OS will create multiple BDs within the original request packet, with each BD including a different virtual address.

Next, this first description is translated. To do this, a buffer address is obtained from this first description and it is determined which physical memory is mapped to that buffer (702). This mapping is based on a second physical memory page size required by a second type of data processing platform. In one embodiment, the IOP driver performs this step by utilizing calls to the commodity OS that translate the virtual buffer address into one or more physical buffer addresses. These physical buffer addresses point to the physical memory that maps to the buffer in virtual address space.

The physical addresses that are obtained in step 702 are used to build a second description that includes one or more I/O operations to physical address space (704). In one embodiment, this second description is contained in the translated request packet. Each I/O operation included in this packet is described in a respective BD that includes a different physical address.

The first description of the I/O operation is then associated with portions of the second description. In one embodiment, this involves associating each of the physical addresses of the translation with a corresponding virtual address from the first description (706). This may include assigning a label to a BD of the first description and storing this label in each associated BD of the translated request packet.

Next, the one or more I/O operations described by the second description are completed, and status regarding the completion of these operations is provided (708). This status may include an error reference to the second description. The associations between the virtual addresses of the first description and the physical addresses of the second description are then used to translate the error reference to the second description into an error reference to the first description (710). If an error occurred, any recovery operations are initiated using the first description (712).

The flow diagrams of FIGS. 6 and 7 are exemplary only, and modifications are possible within the scope of the current invention. For instance, in some cases, some steps may be re-ordered or omitted entirely within the scope of the invention.

The foregoing provides an embodiment wherein legacy OS utilizes a page size that is different from that of commodity platform. In a different embodiment wherein both legacy OS and commodity OS utilize the same page size, a simplified translation mechanism may be utilized wherein a one-to-one correlation exists between the BDs in request packet 302 and the BDs of translated request packet 304. That is, for each BD of request packet 302, exactly one BD will be created in translated request packet 304. The BD of request packet 302 will contain a virtual address, whereas the corresponding BD of translated request packet 304 will contain the physical address that maps to this virtual address.

Next, assume the BDs within request packet 302 reside in the same order within its linked list as the order in which the corresponding BDs of translated request packet 304. In this embodiment, the use of a label field is not necessarily a requirement. This is because after status is generated that points to the translated linked list, the position of the identified BD in translated request packet 304 can be used to identify a corresponding BD in request packet 302 without the use of any label. However, this embodiment does require that a BD's position in the translated request packet is somehow known. If a BD's position can only be obtained by traversing the linked list of BDs in the translated packet, the use of labels provides a performance benefit even in a scenario wherein a one-to-one correspondence exists between the original and translated request packets.

The various polling mechanisms described above provide many advantages, including the ability to utilize legacy OS 200 and legacy IOP 204 without modification on a commodity platform. However, the polling mechanisms require a first translation process to translate request packet 302 into translated request packet 304. This mechanism further requires a second translation process to translate an entry from the completion queue into an entry on a translated completion queue. This may reduce throughput. Therefore, another mechanism may be utilized in the alternative that requires some modifications to legacy OS 200 and/or legacy IOP 204. This is described in reference to a fast-mode embodiment of the system to be described below.

### III. Fast-Mode

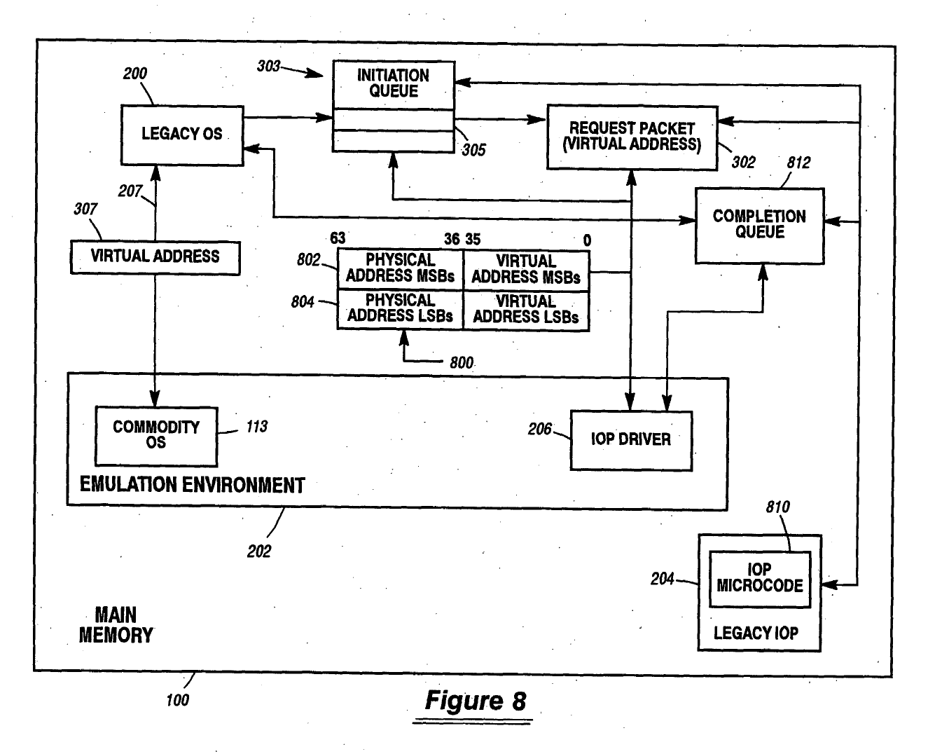

FIG. 8 is a block diagram that illustrates fast mode according to one embodiment of the invention. This diagram includes elements similar to those of FIG. 3 that are designated with like numeric designators.

In fast mode, several modifications to legacy OS 200 are provided. First, legacy OS is modified to utilize the same page size as the commodity OS and the commodity platform. This eliminates the need to translate one BD of a request packet into multiple BDs of a translated request packet, as discussed in reference to FIGS. 4 and 5, above. In addition, legacy OS is modified so that it is “aware” that when legacy OS is passed an address by commodity OS, the allocated memory space must be nailed before I/O operations can occur.

During fast mode, legacy OS makes a request to commodity OS 113 for a buffer to be used as a BD buffer to perform I/O operations. In response, commodity OS 113 allocates the memory and returns a virtual address to legacy OS 200. Legacy OS uses this allocated BD buffer to build a request packet. This request packet includes one or more BDs, each storing a virtual address to a data buffer within an address field of the BD. According to the current invention, the address field of a BD is larger than the virtual address. Thus, the address field of the BD contains some unused bits. In one specific embodiment, the virtual address is interpreted by legacy OS and legacy IOP to be 72 bits wide, whereas the address field is 128 bits wide, resulting in 56 unused bits. These unused bits are employed to implement fast mode in a manner to be described below.

After the legacy OS 200 completes the building of the request packet, legacy OS makes a call to IOP driver 206 to nail the memory allocated for the BD buffer. In response, the IOP driver 206 nails the space as requested.

Next, as part of the call to nail the BD buffer, the IOP driver facilitates the virtual-to-physical address conversion for the request packet. In particular, for each data buffer that is identified by a virtual address stored within the request packet, IOP driver calls the commodity OS′ standard virtual-to-physical address conversion. This call returns a physical address that corresponds to the virtual address. This physical address is stored in the unused bits of the address field for that virtual address. Thus, the virtual address bits are retained within their expected location within the address field, and a corresponding physical address is inserted within the unused bits of this field.

In one embodiment, each address field of request packet 302 is converted to the format shown in block 800 of FIG. 8. That is, the address field contains two 64-bit words. Bits 0-35 of the first word of the address field store the most-significant bits of the virtual address. Similarly, bits 0-35 of the second word of the address field stores the least-significant bits of the virtual address. The most-significant bits of the physical address are stored within the unused bits of the first word of the address field, and the least-significant bits of the physical address are stored within the unused bits of the second word. Many other formats may be used, and the format of FIG. 8 is merely exemplary.

It may be noted that the same type of address conversion that is performed for addresses stored within the request packet must also be performed for the BD buffer that stores this request packet. In other words, the request packet 302 is stored in the BD buffer, which resides in virtual address space. The pointer to request packet 302 that is stored in entry 305 of initiation queue 303 is a 72-bit virtual address. This 72-bit virtual address is stored in a 128-bit-wide address field of entry 305. IOP driver 206 obtains and stores a corresponding physical address in the unused bits of this field. This physical address is then available for use by IOP microcode 810 in locating request packet 302 in physical memory during processing of the I/O request.

In one embodiment, a large request packet may occupy multiple BD buffers that are not necessarily contiguous within virtual address space. These non-contiguous BD buffers are maintained in a linked list using pointers that are 72-bit virtual addresses stored within the BD buffers. Each such pointer is stored within a 128-bit wide address field of a BD buffer. IOP driver 206 converts these virtual addresses in the same manner described above. That is, the IOP driver makes a call to commodity OS 113 to convert each such 72-bit virtual address into a corresponding physical address, which is then stored in the unused bits of the 128-bit wide address field for the pointer. In this way, IOP microcode 810 is able to locate all physical memory areas that contain the various blocks of virtual address space in which request packet 302 resides.

In the foregoing manner, IOP driver 206 not only converts all data buffer addresses that are stored within request packet 302, the IOP driver also translates all addresses that are needed by legacy IOP 204 to access the request packet.

When IOP driver 206 has performed all address conversion, IOP driver returns an acknowledgement to legacy OS 200 that the request nailing operation has been completed. Legacy OS 200 may then set the completion designator in initiation queue 303 (FIG. 3). Legacy IOP 204 may begin processing the packet directly as soon as the completion designator is set without any further translation being performed by IOP driver 206. This is because IOP microcode 810 of legacy IOP has been modified to extract the physical addresses from the most-significant 28 bits of each word of a two-word address field within a BD rather than from the least-significant bits of this field. This physical address is then used to complete the I/O operation without any further translation. Moreover, IOP microcode 810 also uses the most-significant 28 bits of any address pointer to locate portions of the request packet itself.

When the I/O operation described by request packet 302 is completed, legacy IOP 204 creates an entry directly on completion queue 812. Completion queue 812 is a counterpart of translated completion queue 316 (FIG. 3) because it is directly accessible to legacy OS 200. Any address that is placed on the completion queue to identify a BD will be in the format shown in block 800. That is, the virtual address that is expected by the legacy OS 200 will be in the least-significant bits of the address field. The physical address may, or may not, be included in the most-significant bits of this two-word address. Whether this physical address is so included is a design choice, and is based on the revision of IOP microcode 810 that is executing on legacy IOP 204. There may be some situations wherein it is advantageous to include this physical address in the upper bits of the failure pointer 326 if an error occurs.

Several observations may be made regarding the alternative embodiment. First, this embodiment eliminates the need to build translated request packet 304. Thus, translated initiation queue 308, translated request packet 304, and completion queue 312 may be eliminated. This results in increased throughput. To obtain this enhanced processing capability, IOP microcode 810 must be adapted to extract the physical addresses from the previously unused bits of the BD address fields, which in this case are the most-significant address field bits. Additionally, legacy OS 200 must be modified to use the same maximum page size as commodity OS 113. If this last modification is not made, some translation similar to that shown in FIG. 4 is still required. Finally, IOP driver 206 must be modified to convert virtual addresses into the format shown in block 800.

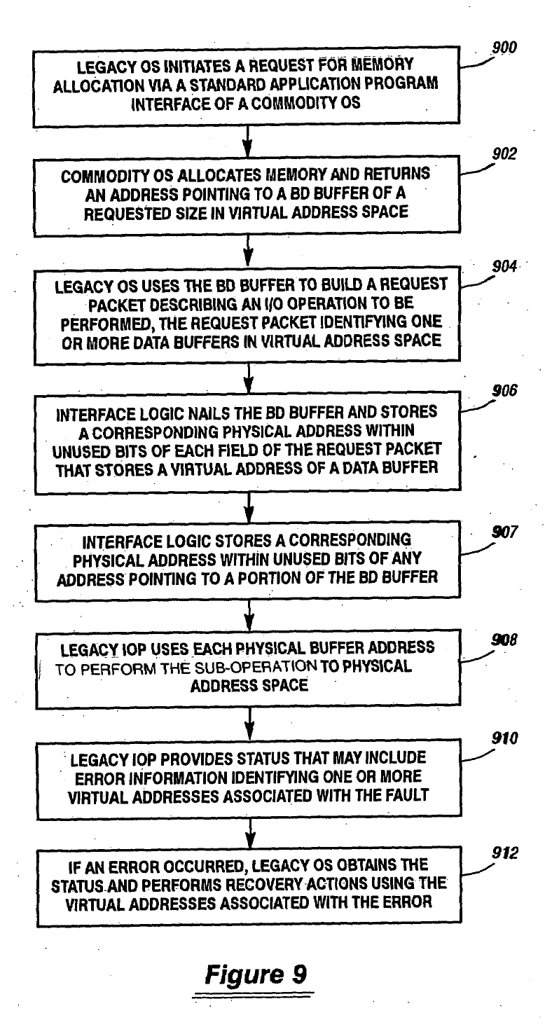

FIG. 9 is a flow diagram of one method according to a fast-mode embodiment of the current invention. First, legacy OS initiates a request for memory allocation via a standard API of a Commodity OS (900). Commodity OS allocates the requested memory and returns an address pointing to a BD buffer of a requested size in virtual address space (902). Legacy OS then builds a request packet in the newly-allocated BD buffer. This request packet describes an I/O operation, and identifies one or more data buffers in virtual address space to which, or from which, data is to be transferred (904). As discussed above, each such data buffer is associated with a respective I/O sub-operation which is a part of the overall I/O operation.

Next, interface logic, which in one embodiment resides within IOP driver 206, nails the allocated memory space containing the BD buffer and stores a corresponding physical address within the unused bits of each field of the request packet that stores a virtual address of a data buffer (906). Stated otherwise, a corresponding physical address is stored within each BD of the request packet. In one embodiment, each of the corresponding physical addresses is obtained via a call to commodity OS′ standard virtual-to-physical address conversion routines.

Interface logic must also store a corresponding physical address within unused bits of any address that points to a portion of the BD buffer itself (907). For instance, this step involves converting the pointer that is stored within the initiation queue 303 to the format shown in block 800 of FIG. 8. If multiple BD buffers are allocated in virtual address space to store the request packet, the pointers linking these BD buffers are also converted to the same format shown in block 800.

Legacy IOP then uses each physical buffer address to perform an I/O sub-operation to physical address space (908). IOP microcode 810 has been modified to retrieve each such physical address to complete each sub-operation that is part of the I/O operation.

After all sub-operations to physical address space are completed, legacy IOP provides status that may include error information. This error information identifies a data buffer in virtual address space (910). In one embodiment, the error information is a failure pointer to a BD in the original request packet 302. The BD stores a virtual address associated with the error. If an error occurred, legacy OS processes any error information and performs recovery actions using the virtual addresses (912).

As previously mentioned, the mechanism described above in reference to FIGS. 8 and 9 not only requires modifications to IOP microcode 810, but also assumes that legacy OS 200 has been modified to use the same maximum page size as that used by commodity OS 113 and commodity platform. If legacy OS is not modified to utilize the same page size as commodity OS, some translation similar to that illustrated by FIG. 4 is still required. This is best described in reference to yet another embodiment of the invention, as follows.

Consider an embodiment that is a hybrid of the foregoing embodiments. In this embodiment, legacy OS 200 has not been adapted to use 4K byte pages, but instead uses a different maximum page size (e.g., 32K pages) available on a legacy platform. However, unlike the embodiment of FIG. 4, in this hybrid embodiment, IOP microcode 810 has been modified to extract physical addresses from the most-significant, rather than the least-significant, bits of a two-word address field.

According to this hybrid embodiment, legacy OS 200 builds a request packet in an acquired BD buffer in the manner described above in regards to FIG. 3. After legacy OS 200 sets a completion designator in entry 305 of initiation queue 303 or uses some other mechanism (e.g., interrupts or messaging) to indicate that request packet 302 is available, IOP driver 206 performs a translation operation similar to that shown in FIG. 4. That is, IOP driver obtains a description of all physical memory that maps to a data buffer in virtual address space. Because legacy OS uses a different page size than commodity OS, one BD of the original request packet may be translated into multiple BDs of the translated request packet.

Unlike the embodiment of FIG. 4, according to this hybrid embodiment, instead of using labels to associate the BDs of the translated request packet to a BD of the original packet, IOP driver instead creates all address fields to be in the format shown in block 800. That is, physical addresses are contained in the formerly-unused bits of the address fields of the translated request packet. For each physical address, a corresponding virtual address is stored in the remaining bits of the same address field. As an example, consider the addresses which would be stored within BDs A1-AX of FIG. 4. A respectively different physical address would be stored within the unused address field bits of each of these BDs, with the remaining bits storing the same virtual address provided by BD A 410.

According to the hybrid embodiment, legacy IOP 204 is modified to obtain the physical address from the unused address field bits of the BD so that the corresponding I/O operation may be completed.

After processing of the translated request packet, and if an error occurred, legacy IOP 204 may create an entry directly in a completion queue accessible to the legacy OS 200. This entry stores a pointer to the translated request packet. Legacy OS 200 may access a BD of the translated request packet to obtain the buffer address in virtual address space that was being used when the failure occurred, eliminating any post-processing translation. This translation may be eliminated because when legacy OS 200 accesses an identified BD within the translated request packet 304, the correct virtual address will be in the expected location within the address field of the BD. In this manner, the hybrid approach allows legacy OS 200 to remain unchanged. Only IOP microcode 810 needs to be updated. Furthermore, no post-processing translation is needed, increasing throughput.

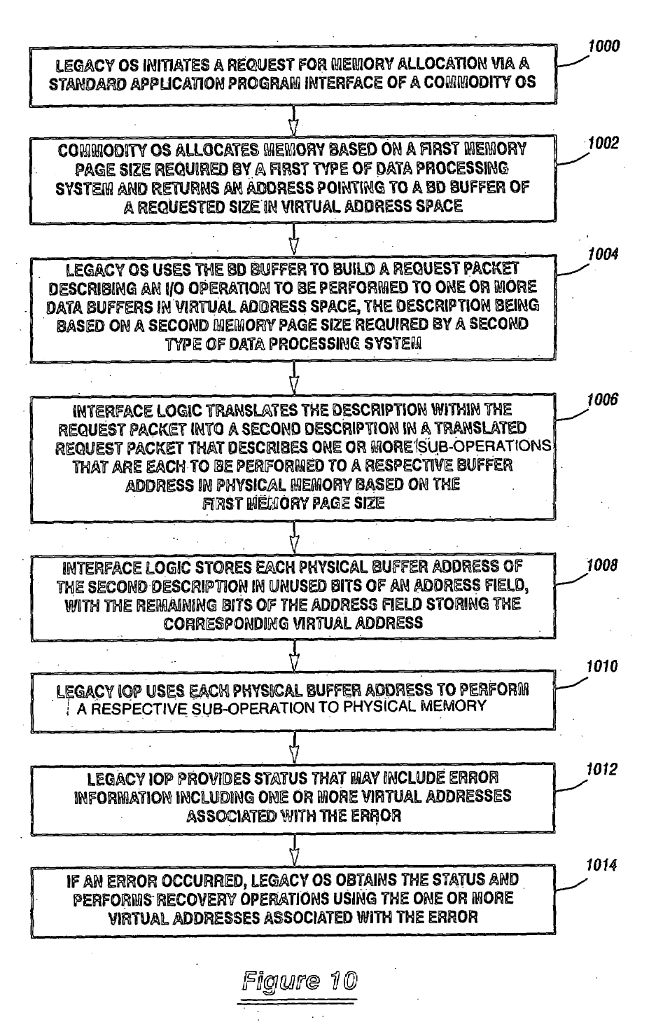

FIG. 10 is a flow diagram of one method according to an alternative hybrid embodiment described above. Legacy OS initiates a request for memory allocation via a standard API of a Commodity OS (1000). Commodity OS allocates the requested memory based on a first memory page size required by a first type of data processing system and returns an address pointing to a buffer in virtual address space (1002). In one embodiment, this first memory page size is 4K bytes based on requirements of commodity-type platforms.

Next, legacy OS uses the newly-allocated buffer to build a request packet that describes an I/O operation to be performed. This I/O operation is described by the request packet as being performed to one or more data buffers in virtual address space. This description is based on a second memory page size required by a second type of data processing system (1004). For example, in one embodiment, this second memory page size is 32K bytes as employed by a second type of data processing system, which is a legacy system. Therefore, the description points to one or more data buffers within virtual address space that may each be up to 32K-bytes in length.

Interface logic, which in one embodiment resides in IOP driver 206, then translates the description within the request packet into a second description. This second description resides in a translated request packet such as that shown in FIG. 4. This translated request packet describes one or more I/O sub-operations, each of which is to be performed to a respective buffer address in physical address space. This description is based on the first memory page size (1006). Thus, this step creates a translated request packet that is similar to translated request packet 304. However, the translated request packet is different than that shown in FIG. 3 because, in step 1008, each buffer address in physical memory is stored in the formerly unused bits of the address field. The corresponding virtual address is stored in the remaining bits. In one embodiment, the data buffer addresses are in the format shown in block 800 of FIG. 8.

Next, legacy IOP uses each physical buffer address in the formerly-unused bits to perform the respective I/O sub-operation to physical address space (1010). Upon conclusion of all of the sub-operations, legacy IOP provides status that may include error information identifying one or more virtual addresses associated with the error (1012). In one embodiment, this involves providing an entry in a completion queue that is accessible to the legacy OS. This entry may contain a pointer identifying a BD in the translated request packet involving an error. In an error occurred, legacy OS retrieves any identified BD of the translated request packet and completes recovery actions for the failed I/O sub-operation using virtual address information (1014).

The foregoing describes various techniques and embodiments utilized to allow a legacy OS and legacy IOP to be employed on a commodity platform (e.g., a PC) with a commodity OS (e.g., Windows®, UNIX, Linux, etc.) This provides the advantages of enhanced data protection, security, and recoverability features generally only available on legacy platforms such as mainframes. While the above description discussed various embodiments of the current invention, it will be recognized that these embodiments are illustrative only, and not limiting, with the scope of the invention to be determined only by the claims that follow.

What is claimed is:

1. A computer-implemented method of performing input/output (I/O) operations, comprising:
building, by a first OS, a first description of an I/O operation that is based on a first memory page size that is different from that used by a data processing system on which the first OS is running;
creating from the first description a translation that is based on a second memory page size used by the data processing system; and
performing, by an I/O processor, one or more I/O sub-operations that are described by the translation.

2. The method of claim 1, including:
allocating, by a second OS that is native to the data processing system, a data buffer to be used to perform the I/O operation; and
providing a virtual address of the data buffer to the first OS for inclusion in the first description.

3. The method of claim 1, wherein the first OS views the virtual address as a physical address.

4. The method of claim 1, and further including emulating the first OS on the data processing system.

5. The method of claim 1, wherein the first description includes a virtual address of a data buffer in virtual address space that is to be used to perform the I/O operation, and further including:
identifying one or more buffers in physical address space that are allocated to the data buffer in virtual address space, wherein each of the one or more I/O sub-operations is performed to a respective one of the one or more buffers in physical address space.

6. The method of claim 5, and including forming an association between each of the one or more buffers in physical address space and the data buffer in virtual address space.

7. The method of claim 6, and further including using each of the associations to translate status describing execution of the one or more I/O sub-operations, whereby the status may be used by the first OS to perform recovery operations.

8. The method of claim 5, wherein each of the associations is formed based on a manner in which the virtual address is stored within the first description.

9. The method of claim 1, wherein the first description describes multiple I/O sub-operations, each of which is associated with a buffer in virtual address space, wherein the creating step includes identifying, for each of the buffers in virtual address space, a corresponding set of one or more buffers in physical address space that are allocated to the buffer in virtual address space, and further comprising creating, for each of the buffers in physical address space, a second description of an associated I/O sub-operation that will use the buffer in physical address space.

10. The method of claim 9, and including:
performing each I/O sub-operation that uses a buffer in the physical address space;
generating status that indicates an error and that identified one of the I/O sub-operations that uses a buffer in physical address space which is associated with the error; and
converting the status to identify a buffer in virtual address space to which the buffer in physical address space is allocated.

11. The method of claim 9, and including associating an I/O sub-operation that will use a buffer in physical address space with an I/O sub-operation that is associated with a buffer in virtual address space based on an order in which the buffer in virtual address space appears within the first description.

12. A data processing system, comprising:
an instruction processor (IP);
a first operating system (OS) being executed by the IP, the first OS being adapted to create a first description of an I/O operation that is based on a first memory page size that is different than a second memory page size utilized by the IP;
a driver coupled to the first OS to create a translation of the first description based on the second memory page size; and
an IOP coupled to the first OS to execute the I/O operation in accordance with the second description.

13. The system of claim 12, and further including a second OS coupled to the first OS via a standard API, the second OS to allocate a data buffer for use in performing the I/O operation, the data buffer being allocated based on the second memory page size.

14. The system of claim 12, wherein the first OS is written in an instruction set other than that native to the IP.

15. The system of claim 14, further including an emulation environment coupling the first OS to the IP.

16. The system of claim 12, wherein the first OS is adapted to include in the first description a virtual address of a data buffer in virtual address space that will be used to perform the I/O operation, and
wherein the driver is adapted to determine one or more buffers in physical address space that are allocated to the data buffer.

17. The system of claim 16, wherein the driver is further adapted to create, for each of the one or more buffers in the physical address space, an association with the buffer in the virtual address space.

18. The system of claim 17, wherein the IOP is adapted to execute a respective I/O sub-operation for each of the one or more buffers in the physical address space, and if an error occurs, to identify one of the buffers in the physical address space that is involved with the error; and
wherein the IOP driver is adapted to use the associations to translate the identification of the buffer in the physical address space to an identification of the buffer in the virtual address space for use by the first OS in performing error recovery.

19. A computer readably medium having stored thereon instructions for performing a method, the method comprising:
allocating, by an Operating System (OS), a buffer based on a memory page size;
providing a virtual address of the buffer to another OS;
building, by the other OS, a description of an I/O operation to be performed using the buffer, the description being based on a memory page size that is different from that used to allocate the buffer;
creating from the description a translated description that is based on the memory page size used to allocate the buffer; and
performing, by an I/O processor compatible with the other OS, the I/O operation as described by the translated description.

20. The medium of claim 19, wherein the method further comprises:
generating, by the I/O processor, status that references the translated description; and
translating the status to reference the description, whereby the other OS utilizes the translated state to complete any recovery processing required for the I/O operation.
